(19) United States
(12) Patent Application Publication
(10) Pub. No.: US 2005/0272595 A1
(43) Pub. Date: Dec. 8, 2005

(54) Manufacturing process for fuel cell, and fuel cell apparatus

(75) Inventors: Motokazu Kobayashi, Kanagawa-ken (JP); Teigo Sakakibara, Kanagawa-ken (JP); Masayuki Yamada, Tokyo (JP); Shinji Eritate, Kanagawa-ken (JP)

Correspondence Address: FITZPATRICK CELLA HARPER & SCINTO, 30 ROCKEFELLER PLAZA, NEW YORK, NY, 10112, US

(73) Assignee: Canon Kabushi Kaisha, Tokyo (JP)

(21) Appl. No.: 10/530,493

(22) PCT Filed: Oct. 15, 2003
(86) PCT No.: PCT/JP03/13177

§ 371 Date: Apr. 6, 2005

(30) Foreign Application Priority Data
Oct. 16, 2002 (JP) 2002302230

(51) Int. Cl. H01M 4/88; H01M 8/10; H01M 4/96; B05D 5/12

(52) U.S. Cl. 502/101; 427/115; 429/44; 429/30

(57) ABSTRACT

In a manufacturing process for a fuel cell having a fuel electrode, an oxidizer electrode, and a polymer electrolyte membrane held between both the electrodes, and having electrode catalyst layers which are individually provided between both the electrodes and the polymer electrolyte membrane, the process has the step of ejecting an electrode catalyst composition containing conductive particles carrying thereon at least a catalyst, by an ink-jet process to form the electrode catalyst layers. This provides a fuel cell manufacturing process which can accurately control the coverage of catalyst layers and also can simply provide pores while controlling the same.

### TECHNICAL FIELD

This invention relates to a process for manufacturing a fuel cell in which hydrogen, reformed hydrogen, methanol, dimethyl ether or the like is used as a fuel and air or oxygen is used as an oxidizing agent.

### BACKGROUND ART

Solid-polymer type fuel cells have a layer structure wherein a fuel electrode (anode) and an air electrode (oxidizer electrode) (cathode) hold a solid-polymer type electrolyte membrane between them. These fuel electrode and air electrode are each formed of a mixture of a catalyst, an electrolyte and a binder; the catalyst being a noble metal such as platinum, or an organometallic complex, carried (supported) on a conductive carbon. The fuel fed to the fuel electrode passes through pores in the electrode to reach the catalyst, and emits electrons by the aid of the catalyst to turn into hydrogen ions. The hydrogen ions pass through the electrolyte membrane held between both the electrodes, to reach the air electrode, and react with oxygen fed to the air electrode and with electrons flowing thereinto from an external circuit. Electrons emitted from the fuel electrode pass through the catalyst in the electrode and the conductive carbon on which the catalyst is carried, and are led out to an external circuit to flow into the air electrode from the external circuit. As the result, in the external circuit, the electrons flow from the fuel electrode toward the air electrode, where electric power is withdrawn.

In the above solid-polymer type fuel cells, a fuel cell is used in which fine carbon powder carrying thereon a noble-metal catalyst is provided on a porous conductive substrate or in the solid-polymer type electrolyte membrane. As a common manufacturing method therefor, conductive fine carbon powder carrying thereon a noble-metal catalyst is dispersed in an organic solvent or the like to make up an ink, and this ink is coated on the substrate by screen printing, transferring, doctor blade coating or wire bar coating to form its layer as a catalyst layer. After this catalyst has been formed, microscopic pores are provided in the catalyst layer by a means such as baking.

In another method, an ink in which catalyst particles have been dispersed is spray-coated on a polymer electrolyte membrane or a porous conductive substrate to make a porous body to form a catalyst layer (see Japanese Patent Application Laid-Open No. 2001-068119).

However, in order to form the catalyst layer by the method such as printing and thereafter form the microscopic pores, it is necessary to keep a pore-forming material added previously to the ink, and remove it by baking or washing after the catalyst layer has been formed. This makes the manufacturing process complicate, or there is a possibility that the catalytic activity deteriorates as a result of the baking or washing.

The method of forming the porous body by spray coating needs no trouble such as baking or washing. However, its droplets forced out are relatively so large that the holes formed tend not to be pores but to be large holes or the coating tends to be in a non-uniform coverage in some places. With an increase in diameter of pores, the active sites at which the catalytic reaction takes place decreases, resulting in less electric power to be withdrawn. The non-uniformity in coverage of such an electricity-generating catalyst may also cause scattering (non-uniformity) in electricity-generating efficiency in some places.

### DISCLOSURE OF THE INVENTION

The present invention is to solve the above problems hitherto involved. Accordingly, an object of the present invention is to provide a fuel cell manufacturing process which can accurately control the coverage of catalyst layers and also can simply provide pores while controlling the same.

Another object of the present invention is to make it possible to produce with ease a fuel cell which can achieve good electricity generation efficiency.

That is, the present invention is a manufacturing process for a fuel cell having a fuel electrode, an oxidizer electrode, and a polymer electrolyte membrane held between both the electrodes, and having electrode catalyst layers which are individually provided between both the electrodes and the polymer electrolyte membrane;

the process comprising the step of ejecting an electrode catalyst composition containing conductive particles carrying thereon at least a catalyst, by an ink-jet process on a layer-forming surface on which each electrode catalyst layer is to be formed.

Preferred embodiments of the present invention are described below.

The fuel cell manufacturing process of the present invention may preferably comprise the step of ejecting the electrode catalyst composition containing conductive particles carrying thereon at least a catalyst, ejecting the same a plurality of times by the ink-jet process within the same one pixel on a layer-forming surface on which each electrode catalyst layer is to be formed.

The electrode catalyst composition may preferably be ejected in a droplet quantity of from 1 pl to 100 pl per droplet.

In another embodiment of the present invention, the manufacturing process may be a manufacturing process for a fuel cell having a fuel electrode, an oxidizer electrode, a polymer electrolyte membrane held between both the electrodes, and electrode catalyst layers which are individually provided between both the electrodes and the polymer electrolyte membrane;

the process comprising the step of ejecting an electrode catalyst composition containing conductive particles carrying thereon at least a catalyst wherein the electrode catalyst composition is ejected a plurality of times in a droplet quantity of from 1 pl to 100 pl per droplet within the same one pixel on a layer-forming surface on which each electrode catalyst layer is to be formed.

The layer-forming surface on which each electrode catalyst layer is to be formed may preferably be each side of the polymer electrolyte membrane.

The fuel cell may further have a diffusion layer between i) at least one of the fuel electrode and the oxidizer electrode and ii) the polymer electrolyte membrane, and the layer-forming surface on which each electrode catalyst layer is to be formed may preferably be at least one of the surfaces which are to face each other, of the polymer electrolyte membrane and the diffusion layer.

The conductive particles may preferably be a conductive carbon.

In the above manufacturing process, it may also concern a manufacturing process for a solid-polymer type fuel cell, in which the electrode catalyst composition is ejected in a droplet quantity of from 1 pl to 100 pl each time.

The present invention is also a fuel cell apparatus having the fuel cell manufactured by the above process.

The present invention also concerns a solid-polymer type fuel cell manufactured by the above process for manufacturing a fuel cell.

Other features and advantages of the present invention will be apparent from the following description in conjunction with the accompanying drawings.

### BRIEF DESCRIPTION OF THE DRAWINGS

FIG. 1 is a partial schematic view showing an example of the fuel cell in the present invention.

FIG. 2 is a graph representing the relationship between electric current and voltage in Examples 1 to 4 of the present invention and Comparative Examples 1 and 2.

### BEST MODE FOR CARRYING OUT THE INVENTION

The present invention is described below in detail with reference to the accompanying drawings.

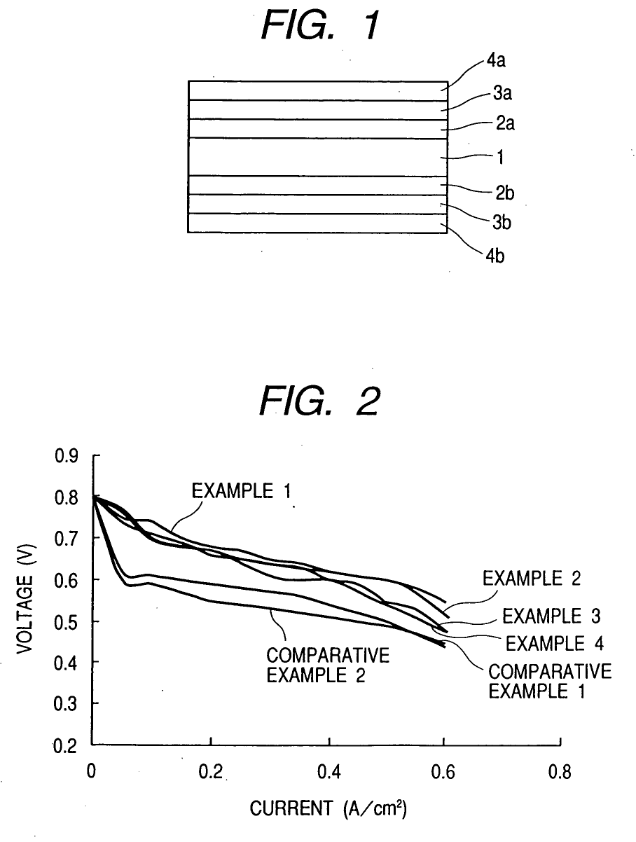

FIG. 1 is a partial schematic view showing an example of the fuel cell in the present invention.

In what is shown in FIG. 1, the fuel cell in the present invention comprises a polymer electrolyte membrane 1, electrode catalyst layers 2a and 2b provided on both sides of the polymer electrolyte membrane 1, diffusion layers 3a and 3b further provided on the outer sides of the electrode catalyst layers 2a and 2b, and an electrode (fuel electrode) 4a and an electrode (oxidizer electrode) 4b which are further provided on the outer sides of the diffusion layers 3a and 3b to serve also as collectors.

In manufacturing the above fuel cell, the electrode catalyst layers 2a and 2b are previously formed on both sides of the polymer electrolyte membrane 1, and the diffusion layers 3a and 3b are separately made ready for use. These layers are then firmly bonded to make up a membrane electrode assembly (MEA). Electrode catalyst layers may also be formed on the diffusion layers 3a and 3b on the polymer electrolyte membrane side.

As the polymer electrolyte membrane 1, what may preferably be used is a perfluorosulfonic-acid polymer film as typified by NAFION membrane, available from Du Pont, or a hydrocarbon membrane available from Hoechst. Without limitation thereto, however, also widely usable are polymer membranes with a functional group having a hydrogen ion conductivity, as exemplified by a sulfonic acid group, a sulfinic acid group, a carboxylic acid group or a phosphonic acid group.

A hybrid electrolyte membrane is also usable which consists of an inorganic electrolyte and a polymer membrane, produced by the sol-gel method.

In order to prevent crossover of fuel, the polymer electrolyte membrane 1 may be provided with a coating on its surface.

The electrode catalyst layer 2a on the fuel electrode side may be formed of an electrode catalyst of a conductive carbon on which at least a platinum catalyst has been carried.

The platinum catalyst that may be used in the present invention may preferably be carried on the surface of the conductive carbon. The catalyst thus carried may preferably have a fine average particle diameter. Stated specifically, it may preferably have an average particle diameter in the range of from 0.5 nm to 20 nm, and more preferably from 1 nm to 10 nm. If it has an average particle diameter of less than 0.5 nm, catalyst particles alone may have so high activity as to be handled with difficulty. If it has an average particle diameter of more than 20 nm, the catalyst has so small surface area as to come in loss of reactive sites, so that there is a possibility of a lowering of activity.

In place of the platinum catalyst, any of platinum group metals such as rhodium, ruthenium, iridium, palladium and osmium or an alloy of platinum and any of these metals may also be used. Especially when methanol is used as fuel, it is prefer able to use an alloy of platinum and ruthenium.

The conductive carbon may preferably have an average particle diameter in the range of from 5 nm to 1,000 nm, and more preferably in the range of from 10 nm to 100 nm. Also, in order to make the conductive carbon carry the catalyst, it is better for the former's specific surface area to be large to a certain degree. Thus, the conductive carbon may preferably have a BET specific surface area of from 50 m²/g to 3,000 m²/g, and more preferably from 100 m²/g to 2,000 m²/g.

As methods by which the catalyst is carried on conductive carbon particle surfaces, known methods may widely be used. For example, a method is known in which the conductive carbon is impregnated with a melt of noble metal used as the catalyst, specifically platinum and other metal, and thereafter these noble metal ions are reduced so as to be carried on the conductive carbon particle surfaces (a wet process), including methods disclosed in Japanese Patent Applications Laid-Open No. H02-111440 and No. 2000-113712. Also, the noble metal to be carried may be set as a target so that it is carried on the conductive carbon particle surfaces by vacuum film formation (a dry process).

The conductive carbon may also be combined on its particle surfaces with an organic group capable of dissociation into ions (an ion-dissociative organic group) so that it can be improved in dispersibility required when it is made into an electrode catalyst composition described later. As a preferable ion-dissociative organic group, it may include a sulfonic acid group or salts thereof, a phosphonic acid group or salts thereof, a sulfinic acid group or salts thereof, a carboxylic acid group or salts thereof, and quaternary ammonium salts.

As a specific method for the combination with the organic group, the method may be used which is disclosed in National Publication (of PCT application) No. H10-510863 and No. H10-510862.

The catalyst carried on the conductive carbon may desirably be carried in an amount of from 5 to 80% by weight, and preferably from 10 to 70% by weight, based on the total weight of the conductive carbon and catalyst. If it is in an amount of less than 5% by weight, there is a possibility that no sufficient catalytic performance is brought out. Its use in an amount of more than 80% by weight is not preferable because a high production cost for the catalyst may result or the catalyst may be handled with great difficulty in its production process.

The electrode catalyst thus produced is mixed alone with a solvent, water and so forth, or together with a binder, a polymer electrolyte, a water-repellent, a conductive carbon, a surface-active agent and so forth, followed by dispersion to make up an electrode catalyst composition that can be ejected by an ink-jet process. The electrode catalyst contained in the electrode catalyst composition may desirably be in a content of from 0.5 to 40 parts by weight, and preferably from 1 to 30 parts by weight.

As a preferable solvent, it may include, e.g., butyl alcohol, isopropyl alcohol, ethoxyl alcohol, pentyl alcohol, butyl acetate, glycerol and diethylene glycol.

The electrode catalyst composition thus prepared is ejected to the surface(s) of the polymer electrolyte membrane and/or diffusion layer(s) by an ink-jet process making use of an ink-jet apparatus, thus pixels are formed.

The ink-jet apparatus used may be operated by, but not particularly limited to, an ink-jet process employing an ejection system such as a thermal system or a piezoelectric system.

As the ink-jet process in the present invention, the process may be used that is usually used to form images, characters and the like by ejection of ink.

The size and shape of each pixel depends on the size, design, uses and so forth of the fuel cell to be manufactured, and may be any size of from tens of microns to tens of centimeters, and any shape.

A plurality of pixels may also be formed on the same side(s) of the polymer electrolyte membrane and/or diffusion layer(s), and may be used as they are or may be used in the form that they are cut off for each pixel.

In forming the electrode catalyst layers by means of the ink-jet apparatus, it may unwantedly occur that the layer thickness comes non-uniform in the same pixel or uncoated regions are formed. Accordingly, it is preferable to eject the electrode catalyst composition at least twice in the same pixel.

The electrode catalyst composition may be ejected in a droplet quantity in the range of from 1 pl to 100 pl, and preferably from 1 pl to 60 pl, each time. If its droplet quantity is less than 1 pl, although there is no problem on performance required as the fuel cell, it takes a time to form pixels, resulting in a rise in manufacturing cost. If on the other hand its droplet quantity is more than 100 pl, the pores come to have large diameter, resulting in a low electricity generation efficiency.

The droplet quantity may be changed in the same pixel within the range of from 1 pl to 100 pl.

Upon ejection of the electrode catalyst composition in pixels in the form of droplets, there come portions where droplets are isolated and portions where droplets overlap partly, so that pores are formed in the electrode catalyst layers after the droplets have been dried. As the size of the pores, the pores may preferably be formed in a regular form in an average diameter within the range of from 0.001 to 0.05 μm, and more preferably from 0.002 to 0.04 μm.

The polymer electrolyte membrane and/or diffusion layer(s) on which the pixels have been formed may thereafter preferably be heated to remove the solvent and water contained in the electrode catalyst composition (ink). The ink may also be ejected while the polymer electrolyte membrane and/or diffusion layer(s) is/are heated.

In the case of the fuel cell shown in FIG. 1, the polymer electrolyte membrane 1 and diffusion layers 3a and 3b made up as described above are bonded (brought into firm adhesion) interposing between them the electrode catalyst layers 2a ad 2b, respectively, having been formed on the polymer electrolyte membrane 1. Additional electrode catalyst layers may also be formed on the diffusion layers 3a and 3b. Especially where the electrode catalyst layers are thus provided on both the polymer electrolyte membrane and the diffusion layers, the electrode catalyst layers may be bonded to each other.

It does not matter how they are bonded. It is common to use a method in which these are sandwiched under simultaneous application of heat and pressure.

The diffusion layers 3a and 3b can uniformly introduce into the electrode catalyst layers the fuel such as hydrogen, reformed hydrogen, methanol and dimethyl ether and the oxidizing agent such as air and oxygen, and also comes into contact with the electrodes to interchange electrons. What is commonly preferred is a conductive porous membrane, and used is carbon paper, carbon cloth or a composite sheet of carbon and polytetrafluoroethylene.

The surfaces and pore interiors of the diffusion layers may be coated with a fluorine type coating material to make water repellency treatment.

As the electrodes 4a and 4b, those used conventionally may be used without any particular limitations as long as they can feed the fuel and oxidizing agent to the respective diffusion layers in a good efficiency and also can deliver and receive electrons to and from the diffusion layers.

The fuel cell in the present invention is made up by superposing in layers, e.g., the polymer electrolyte membrane, the electrode catalyst layers, the diffusion layers and the electrodes as shown in FIG. 1. It may have any desired shape, and may also be fabricated by a conventional method without any particular limitations.

The present invention is described below in greater detail by giving Examples. The present invention is by no means limited to the following Examples.

### PRODUCTION EXAMPLES OF ELECTRODE CATALYST INKS

### Production Example 1

Using VULCAN XC72-R (available from Cabot Corporation; average particle diameter: 30 nm) (55% by weight) as the conductive carbon, its particle surfaces were made to carry a platinum (30% by weight)—ruthenium (15% by weight) alloy as the catalyst by the wet process. In order to improve dispersibility, sodium phenylsulfonate was further combined with the carbon particle surfaces by the method disclosed in National Publication No. H10-510862.

In 10 g of this conductive carbon having the catalyst carried thereon, 50 g of a 5% NAFION-butanol solution (available from Wako Pure Chemical Industries, Ltd.) and 250 g of butanol were well mixed to disperse the former in the latter. Thereafter, the resultant dispersion was mixed with 160 g of water and few drops of a surface-active agent to obtain a electrode catalyst composition.

### Production Example 2

Using VULCAN XC72-R (available from Cabot Corporation; average particle diameter: 30 nm) (60% by weight) as the conductive carbon, its particle surfaces were made to carry platinum (40% by weight) as the catalyst, and, in order to improve dispersibility, sodium phenylsulfonate was further combined with the carbon particle surfaces, both by the same methods as in Production Example 1.

In 10 g of this conductive carbon having the catalyst carried thereon, 50 g of a 5% NAFION solution (available from Wako Pure Chemical Industries, Ltd.) and 250 g of butanol were well mixed to disperse the former in the latter. Thereafter, the resultant dispersion was mixed with 160 g of water and few drops of a surface-active agent to obtain a electrode catalyst composition.

### Production Example 3

Using KETJEN BLACK EC600JD (available from Lion Corporation; average particle diameter: 35 nm) (60% by weight) as the conductive carbon, its particle surfaces were made to carry a platinum (25% by weight)—ruthenium (15% by weight) alloy as the catalyst by the same method as in Production Example 1. Ammonium phenylsulfonate was further combined with this conductive carbon by the method disclosed in National Publication No. H10-510863.

In 10 g of this conductive carbon having the catalyst carried thereon, 50 g of a 5% NAFION solution (available from Wako Pure Chemical Industries, Ltd.) and 250 g of butanol were well mixed to disperse the former in the latter. Thereafter, the resultant dispersion was mixed with 150 g of water and few drops of a surface-active agent to obtain a electrode catalyst composition.

### Production Example 4

Using KETJEN BLACK EC600JD (available from Lion Corporation; average particle diameter: 35 nm) (60% by weight) as the conductive carbon, its particle surfaces were made to carry platinum (40% by weight) as the catalyst by the same method as in Production Example 1. Sodium benzenecarboxylate was further combined with this conductive carbon by the method disclosed in National Publication No. H10-510863.

In 10 g of this conductive carbon having the catalyst carried thereon, 50 g of a 5% NAFION solution (available from Wako Pure Chemical Industries, Ltd.) and 250 g of butanol were well mixed to disperse the former in the latter. Thereafter, the resultant dispersion was mixed with 150 g of water and few drops of a surface-active agent to obtain a electrode catalyst composition.

### Examples 1 to 4 & Comparative Examples 1 and 2

Using NAFION 112 (available from Du Pont; layer thickness: about 50 μm) and TGP-H-030 (available from Toray Industries, Inc.; layer thickness: about 190 μm) as a polymer electrolyte membrane and as two sheets of diffusion layer carbon paper, respectively, for each of Examples 1 to 4, the electrode catalyst compositions (inks) of Production Examples 1 to 5 were each filled into an ink tank, and ejected by an ink-jet process to form pixels.

Each electrode catalyst composition was ejected on one side of the polymer electrolyte membrane to form pixels, followed by drying by means of a 50° C. vacuum dryer. Thereafter, on the back of the polymer electrolyte membrane on which the pixels were formed, the electrode catalyst composition was so ejected that pixels overlap, to form pixels.

The ejection of each electrode catalyst composition was performed in a droplet quantity of from 10 to 15 pl each time.

Conditions and so forth in forming the pixels are shown in Table 1 below. The ejection quantity, which means total amount of ejected droplets, was so controlled that the metal catalyst(s) such as platinum and/or ruthenium corresponded to about 10 mg/cm².

As to the NAFION membrane, the pixels were formed on both sides; and as to the carbon paper, on one side on the membrane side of each sheet. Thereafter, these were put into a 50° C. vacuum dryer to make them dry. Thereafter, with the polymer electrolyte membrane at the center, the polymer electrolyte membrane with pixels and the two sheets of carbon paper with pixels were so bonded that their pixels were face to face put together. Thereafter, these were further firmly bonded at 120° C. and at a pressure of 4.9 MPa (50 kg/cm2). Thus, MEAs (membrane electrode assemblies) of Examples 1 to 4 were produced.

As Comparative Examples 1 and 2, pixels were formed in the same manner as in Examples 3 and 2, respectively, except that, without use of the ink-jet apparatus, the inks were ejected using a spray coater (nozzle orifice size: 1 mm) under conditions of a spraying pressure of 1 kgf/cm and a nozzle height of 10 cm. Thereafter, the subsequent procedure was repeated to produce MEAs of Comparative Examples 1 and 2. Here, a mask was used to form the like pixels.

TABLE 1

| | Fuel | Air | |
|---|---|---|---|
| | Electrode | Electrode | |
| | Side Polymer | Side Polymer | |
| | Electrolyte | Electrolyte | |
| | Membrane and | Membrane and | |
| | Carbon Paper | Carbon Paper | Pixel Size |
| Example 1 | Production | Production | 5 cm × 5 cm |
| | Example 1 | Example 2 | |
| Example 2 | Production | Production | 4 cm × 4 cm |
| | Example 3 | Example 4 | |
| Example 3 | Production | Production | 1 cm |
| | Example 1 | Example 2 | diameter |
| Example 4 | Production | Production | 1 cm |
| | Example 1 | Example 5 | diameter |
| Comparative | Production | Production | 1 cm |
| Example 1 | Example 1 | Example 2 | diameter |
| Comparative | Production | Production | 4 cm × 4 cm |
| Example 2 | Example 3 | Example 4 | |

(Evaluation)

MEAs produced as described above were set in fuel cells to set up respective fuel cells. In respect of each fuel cell, an aqueous 5% by weight methanol solution was fed to the fuel electrode side at a rate of 10 ml/min/cm², and normal-pressure air was fed to the air electrode (oxidizer electrode) side at a rate of 200 ml/min/cm² to effect electricity generation while keeping the temperature of the whole fuel cell at 75° C. The relationship between electric current and voltage of the fuel cells of Examples 1 to 4 and Comparative Examples 1 and 2 are shown in FIG. 2.

As can be seen therefrom, in the fuel cells of Examples 1 to 4, output can stably be withdrawn up to 0.5 A/cm², whereas in Comparative Examples 1 and 2 the output which can be withdrawn is small.

In Examples of the present invention, any steps of washing, baking and the like were not carried out after the electrode catalyst composition was ejected. Also, in Examples of the present invention, the electrode catalyst composition was used only for the portion corresponding to the size of each pixel. In Comparative Examples, however, the electrode catalyst deposited on the mask came wastefull.

The electrode catalyst layers formed were also observed on an electron microscope to find that pores of about 0.03 μm in average diameter stood formed regularly in those of Examples 1 to 4, whereas, in Comparative Examples 1 and 2, pores were tens of micrometers to hundreds of micrometers in average diameter.

### INDUSTRIAL APPLICABILITY

As described above, according to the present invention, a fuel cell manufacturing process can be provided which can accurately control the coverage of catalyst layers and also can simply provide pores while controlling the same. As the result, this enables manufacture of fuel cells which can achieve good electricity generation efficiency.

1. A manufacturing process for a fuel cell having a fuel electrode, an oxidizer electrode, and a polymer electrolyte membrane held between both the electrodes, and having electrode catalyst layers which are individually provided between both the electrodes and the polymer electrolyte membrane;
the process comprising the step of ejecting an electrode catalyst composition containing conductive particles carrying thereon at least a catalyst, by an ink-jet process on a layer-forming surface on which each electrode catalyst layer is to be formed.

2. The process according to claim 1, which further comprises the step of ejecting the electrode catalyst composition containing conductive particles carrying thereon at least a catalyst, ejecting the same a plurality of times by the ink-jet process within the same one pixel on a layer-forming surface on which each electrode catalyst layer is to be formed.

3. The process according to claim 1, wherein the electrode catalyst composition is ejected in a droplet quantity of from 1 pl to 100 pl per droplet.

4. The process according to claim 1, wherein the layer-forming surface on which each electrode catalyst layer is to be formed is each side of the polymer electrolyte membrane.

5. The process according to claim 1, wherein the fuel cell further comprises a diffusion layer between i) at least one of the fuel electrode and the oxidizer electrode and ii) the polymer electrolyte membrane, and the layer-forming surface on which each electrode catalyst layer is to be formed is at least one of the surfaces which are to face each other, of the polymer electrolyte membrane and the diffusion layer.

6. The process according to claim 1, wherein the conductive particles comprise a conductive carbon.

7. A fuel cell apparatus comprising the fuel cell manufactured by the process according to claim 1, a housing which houses the fuel cell, and an electricity-withdrawing electrode for withdrawing to the outside the electricity generated in the fuel cell.

8. A manufacturing process for a fuel cell having a fuel electrode, an oxidizer electrode, a polymer electrolyte membrane held between both the electrodes, and electrode catalyst layers which are individually provided between both the electrodes and the polymer electrolyte membrane;
the process comprising the step of ejecting an electrode catalyst composition containing conductive particles carrying thereon at least a catalyst wherein the electrode catalyst composition is ejected a plurality of times in a droplet quantity of from 1 pl to 100 pl per droplet within the same one pixel on a layer-forming surface on which each electrode catalyst layer is to be formed.

9. The process according to claim 8, wherein the layer-forming surface on which each electrode catalyst layer is to be formed is each side of the polymer electrolyte membrane.

10. The process according to claim 8, wherein the fuel cell further comprises a diffusion layer between i) at least one of the fuel electrode and the oxidizer electrode and ii) the polymer electrolyte membrane, and the layer-forming surface on which each electrode catalyst layer is to be formed is at least one of the surfaces which are to face each other, of the polymer electrolyte membrane and the diffusion layer.

11. The process according to claim 8, wherein the conductive particles comprise a conductive carbon.

12. The process according to claim 8, wherein the fuel cell is a solid-polymer type fuel cell.

13. A fuel cell apparatus comprising the fuel cell manufactured by the process according to claim 8, a housing which houses the fuel cell, and an electricity-withdrawing electrode for withdrawing to the outside the electricity generated in the fuel cell.
